(19) United States
(12) Patent Application Publication
(10) Pub. No.: US 2014/0347568 A1
(43) Pub. Date: Nov. 27, 2014

(54) DISPLAY SYSTEM HAVING DISPLAY PANAL AND PROJECTOR

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 14/288,313

(22) Filed: May 27, 2014

(30) Foreign Application Priority Data
May 24, 2013 (TW) 102118547

(51) Int. Cl. H04N 5/64

(52) U.S. Cl. CPC H04N 5/64
USPC 348/836

(57) ABSTRACT

A display system includes a background screen, a display device, two projectors, and a controller. The display device is placed in front of or mounted to the background screen. The projectors are positioned at two respective opposite sides of the display device and project onto the background screen. The controller is in communication with the display device and the projectors. The controller receives signals of video or still image(s) from a media source, and processes the signals such that the signals are displayable on the display device. The processor controls the display device to display the signals, and further controls the projectors to project background video or still images onto the background screen.

### FIELD

The present disclosure relates to display systems, and particularly, to a display system including a display panel and a projector

### BACKGROUND

Nowadays, televisions (TVs) are widely used. The TV can be placed in front of or directly mounted to a background wall. The TV can include a display panel, such as a liquid crystal display panel, for displaying video or still image(s).

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a top view of an embodiment of a display system.

FIG. 2 is a front view of an embodiment of the display system of FIG. 1.

FIG. 3 is a functional block diagram of an embodiment of the display system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the drawings.

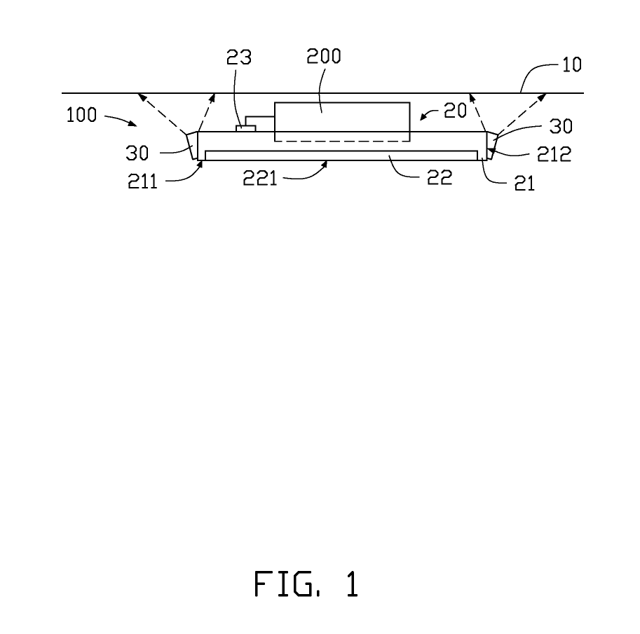

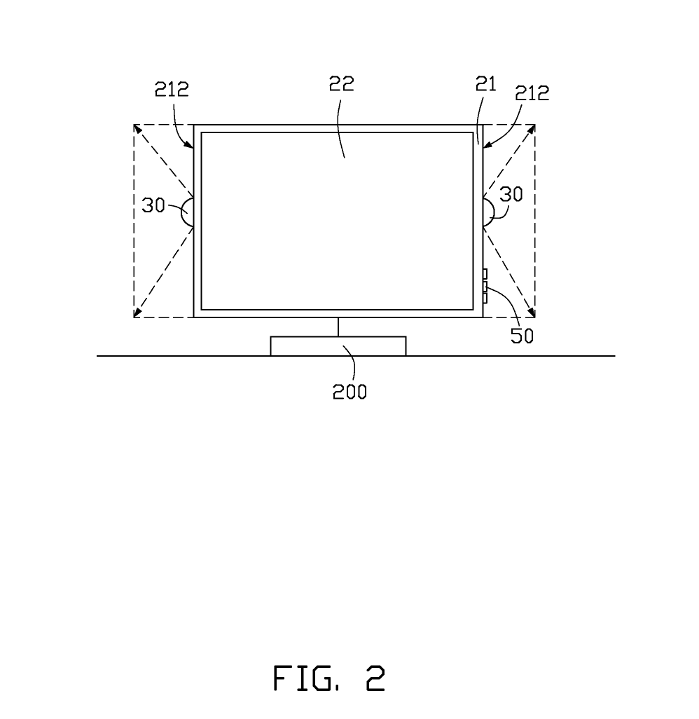

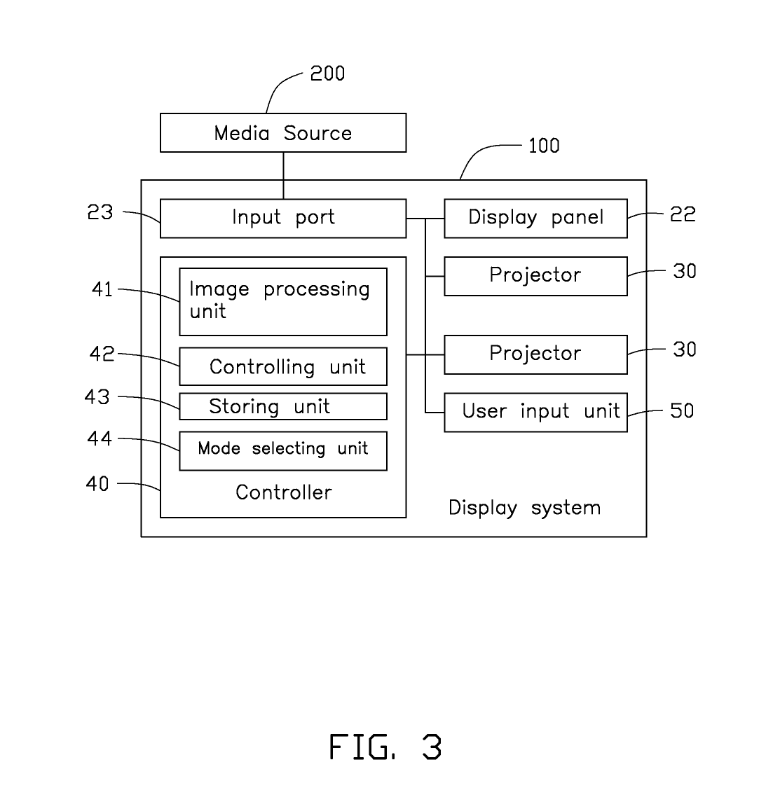

FIGS. 1-3 illustrate an embodiment of a display system 100. The display system 100 includes a background screen 10, a display device 20 placed in front of or mounted to the background screen 10, two projectors 30 located at two respective opposite sides of the display device 20 and facing toward the background screen 10, and a controller 40 controlling the display device 20 and the projectors 30. Referring to FIG. 3, the controller 40 includes an image processing unit 41 and a controlling unit 42. The image processing unit 41 is configured to receive video signals or still images (hereinafter “visual signals”) from a media source 200, and further configured to process the visual signals. The visual signals are displayable on the display device 20 after they are processed by the image processing unit 41. The controlling unit 42 controls the display device 10 to display the visual signals, and further controls the projectors 30 to project background video or background still images (hereinafter “background visual signals”) onto the background screen 30. As such, the background screen 30 can show the background visual signals for contents displayed on the display device 20 to improve a viewing experience.

The media source 200 can be a set top box, a digital versatile disc (DVD) player, a computer, or other media player.

The display device 20 can be a television, and the background screen 10 can be a wall behind the television. A size of the background screen 10 is larger than a size of the display device 20, and the display device 10 can be positioned at a substantially central portion of the background screen 10.

The display device 20 includes a casing 21 and a display panel 22. The casing 21 includes a front surface 211 and two opposite sides 212. The display panel 22 is embedded in the front surface 211, and the two projectors 30 are attached to the two sides 212. In one embodiment, the display panel 22 is a liquid crystal display.

The display panel 22 includes a screen 221. The screen 221 is substantially parallel to and faces away from the background screen 10. In one embodiment, the screen 221 covers portions of the casing 21. As such, the screen 221 can be almost seamlessly connected with the background screen 10.

The display device 20 includes an input port 23 embedded in the casing 21. The controller 40 is received within the casing 21 and electrically connected to the input port 23, the display panel 22, and the projectors 30. The controller 40 receives the visual signals through the input port 23. The input port 23 can be a video graphics adapter.

The display system 100 also includes a user input unit 50. The user input unit 50 is also electrically connected to the controller 40 and is configured to receive user input. The controller 40 includes a storing unit 43 and a mode selecting unit 44. The storing unit 43 is configured to store data of the background visual signals. The mode selecting unit 44 is connected to the user input unit 50 and configured for signaling the controlling unit 42 to switch the projectors 30 between a first mode and a second mode. In one embodiment, when the projectors 30 are in the first mode, the projectors 30 project background visual signals onto the background screen 10 to cooperatively display a video or image with the display panel 22. When the projectors 30 are in the second mode, the projectors 30 project background visual signals onto the background screen 10 that are different from the visual signals of the display panel 22. The user input unit 50 can be a keyboard mounted on the casing 21.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A display system, comprising:
a background screen;
a display device placed in front of or mounted to the background screen;
two projectors positioned at two opposite sides of the display device and aiming at the background screen;
a controller in communication with the display device and the projectors, the controller comprising an image processing unit and a controlling unit, the image processing unit being configured for receiving signals of video or still image(s) from a media source and configured for processing the signals such that the signals are displayable on the display device, the controlling unit controlling the display device to display the signals and the projectors to project background video or still images on the background screen.

2. The display system of claim 1, wherein the background screen is a background wall of television.

3. The display system of claim 1, wherein the display device is a television.

4. The display system of claim 1, wherein the display device comprises a substantially rectangular casing and a display panel, the casing comprises a front surface and the two opposite sides, the display panel is embedded into the front surface, and the two projectors are attached to the two sides.

5. The display system of claim 4, wherein the display panel is a liquid crystal display panel.

6. The display system of claim 4, wherein the display device comprises an input port embedded in the casing, the controller is received within the casing and electrically connected to the input port, the display panel, and the projectors.

7. The display system of claim 4, further comprising a user input unit in communication with the controller and configured for receiving a user input, the controller comprising a storing unit and a mode selecting unit, the storing unit being configured for storing data of background video or still image(s), the mode selecting unit being connected to the user input unit and configured for signaling the controlling unit to switch the projectors between a first mode and a second mode, the controlling unit controlling each projector to display the signals as the background video or still image(s) in the first mode, the controlling unit controlling each projector to display the data of video and still image(s) as the background video or still image(s) in the second mode.

8. The display system of claim 7, wherein the user input unit is a keyboard mounted on the casing.
